(19) United States
(12) Patent Application Publication
(10) Pub. No.: US 2003/0177835 A1
(43) Pub. Date: Sep. 25, 2003

(54) Ball type vibration sensor

(76) Inventor: Jung-Tsung Wei, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/100,042

(22) Filed: Mar. 19, 2002

(51) Int. Cl. G01P 15/135

(52) U.S. Cl. 73/652

(57) ABSTRACT

A vibration sensor includes a first pawl having a first connection leg and a plurality of first prongs extend from the first connection legs. A second pawl has a second connection leg and a plurality of second prongs extend from the second connection leg. The first prongs are arranged alternatively located between the second prongs so as to define a space and a ball is located in the space and in contact with one of the first prongs and one of the second prongs. When a vibration is detected, only one or none of the first prongs and the second prongs is not in contact with the ball, and a signal is sent by the legs.

### FIELD OF THE INVENTION

The present invention relates to a sensor which includes two pawls each having prongs alternatively arranged to define a space in which at least one ball is received. When the position of the at least one ball changes, a corresponding signal is sent to a control center to sense the vibration.

### BACKGROUND OF THE INVENTION

A conventional vibration sensor is shown in FIGS. 1 and 2, and includes a hollow box 11 which has an open bottom with a cap engaged therewith. A ball 12 is received in the hollow box 11 and two conductive members 13, 14 extend through the cap and two respective heads of the two conductive members 13, 14 support the ball 12 in the box 11. The two conductive members 13, 14 are connected to a control center which is not shown. When vibration is happened to the sensor, the ball 12 is not in contact one of the two conductive members 13, 14, or both of the two conductive members 13, 14 are no in contact with the ball 12. This generates a different signal to the control center so that a warning signal is created to inform people that a vibration is detected. The box 11 of the conventional sensor has to be positioned upright so that the ball 12 is well supported by the two conductive members 13, 14. This limits the ways of use of the sensors and only limited direction of vibrations can be detected.

### SUMMARY OF THE INVENTION

In accordance with one aspect of the present invention, there is provided a vibration sensor which comprises a first pawl having a first connection leg and a plurality of first prongs extend from the first connection legs. A second pawl has a second connection leg and a plurality of second prongs extend from the second connection leg. The first prongs are arranged alternatively located between the second prongs so as to define a space and a ball is located in the space and in contact with one of the first prongs and one of the second prongs.

The primary object of the present invention is to provide a ball type vibration sensor which can be used in any direction and is able to detect a vibration from any direction.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional vibration sensor;

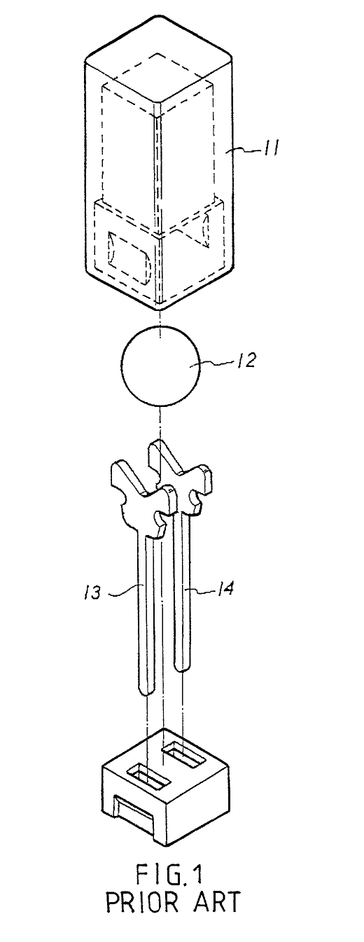

FIG. 2 is a cross sectional view to show the conventional vibration sensor;

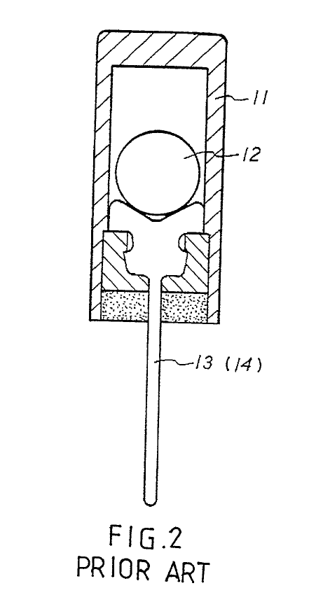

FIG. 3 is an exploded view to show the vibration sensor of the present invention;

FIG. 4 is a perspective view to show the vibration sensor of the present invention;

FIG. 5 is a plan view to show the vibration sensor of the present invention;

FIG. 6 is an exploded view to show the vibration sensor of the present invention wherein the prongs has a triangular cross section;

FIG. 7 is an exploded view to show the vibration sensor of the present invention wherein the prongs has a circular cross section;

FIG. 8 is a perspective view to show the vibration sensor of the present invention as shown in FIG. 7;

FIG. 9 is an exploded view to show the vibration sensor of the present invention wherein the prongs has multiple sections;

FIG. 10 is an exploded view to show the vibration sensor of the present invention wherein two balls are located in the space enclosed by the prongs, and

FIG. 11 is a perspective view to show the vibration sensor of the present invention as shown in FIG. 10.

### DETAILED DESCRIPTION OF THE PREFERRED EMBODIMENT

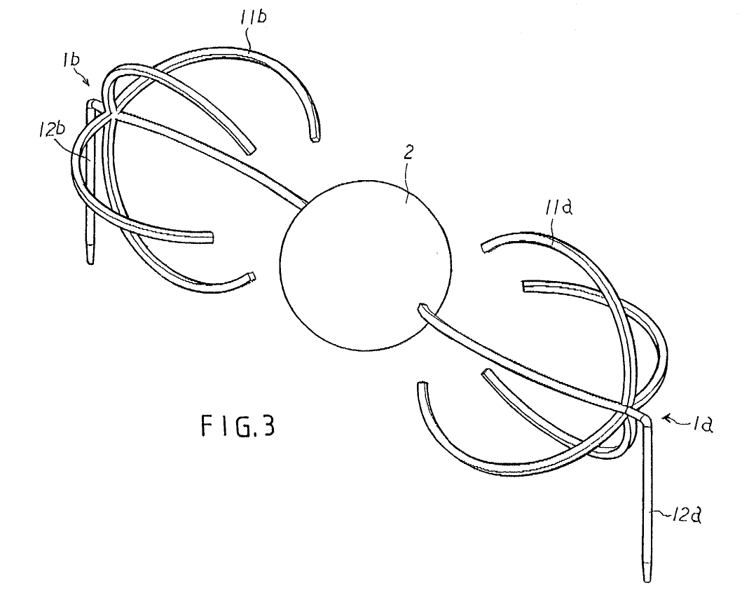

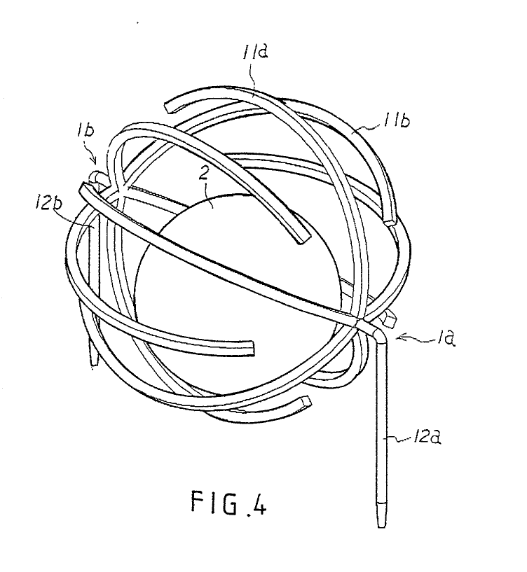

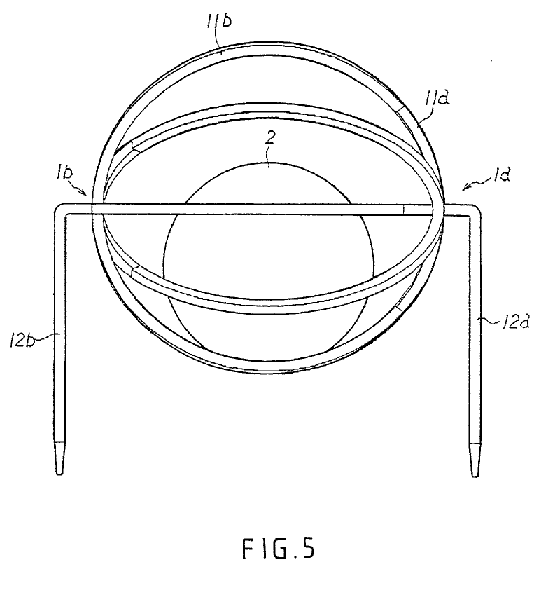

Referring to FIGS. 3 to 5, the vibration sensor of the present invention comprises a first pawl 1a which has a first connection leg 12a and a plurality of first prongs 11a extend from an extension section from an end of the first connection legs 12a.

A second pawl 1b has a second connection leg 12b and a plurality of second prongs 11b extend from an extension section from an end of the second connection leg 12b. Each of the first prongs 11a and the second prongs 11b has a curvature and the first prongs 11a are arranged alternatively located between the second prongs 11b so as to define a space.

A ball 2 is located in the space and in contact with one of the first prongs 11a and one of the second prongs 11b. The first leg 12a and the second leg 12b are respectively connected to a control center which is not shown. The status that the ball 2 is in contact with one of the first prongs 11a and one of the second prongs 11b is a normal status. When a vibration is detected, the ball 2 rolls and one of the first prongs 1a or one of the second prongs 1b, or both of them is not in contact with the ball 2 so that a vibration signal is sent by the control center to claim a vibration situation.

The vibration sensor of the present invention can be installed in any direction and the vibration can also be detected whichever direction it I shappened.

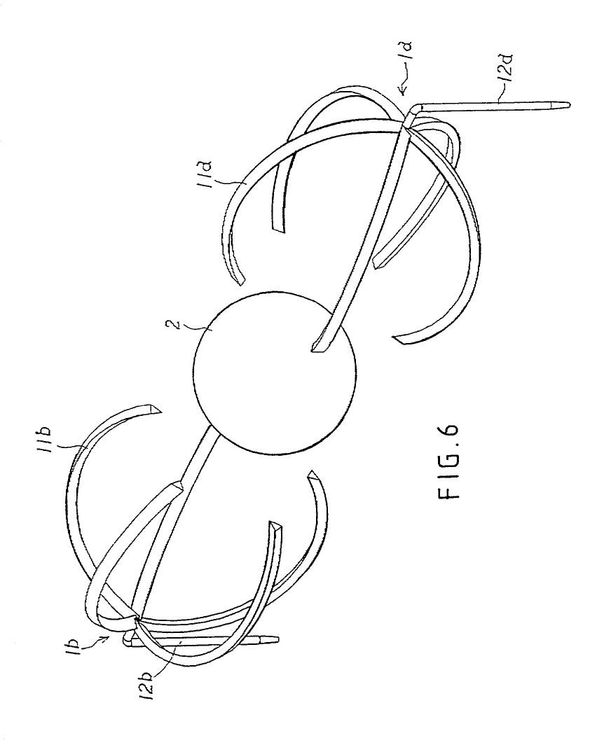

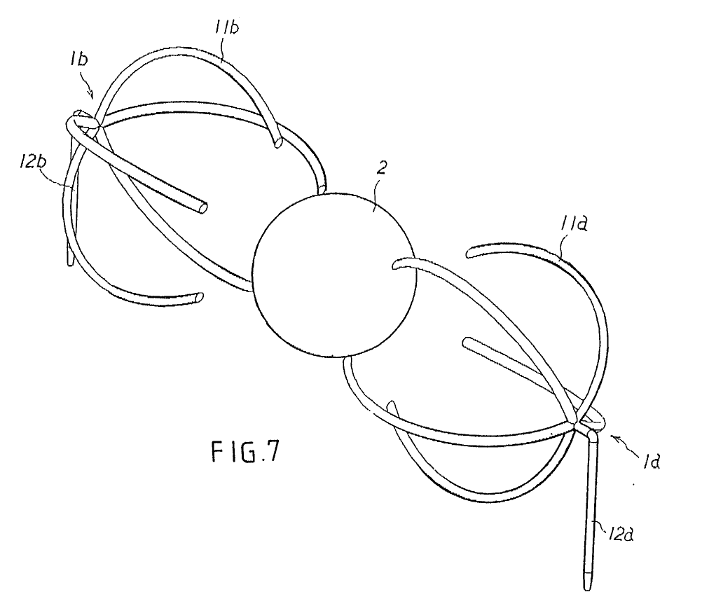

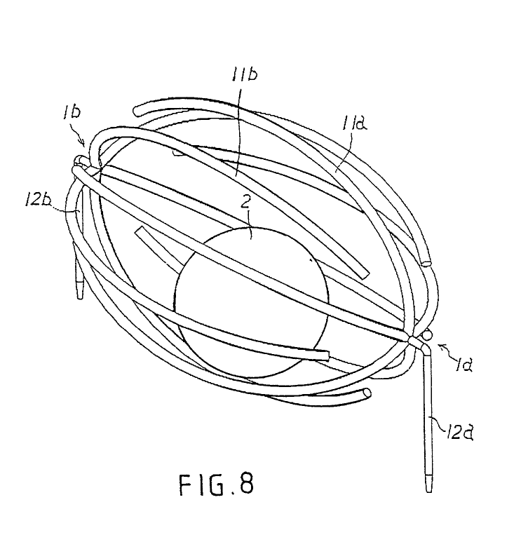

FIG. 6 shows that each of the first prongs 11a and the second prongs 11b may have a triangular cross section. FIGS. 7 and 8 show that each of the first prongs 11a and the second prongs 11b may have a circular cross section.

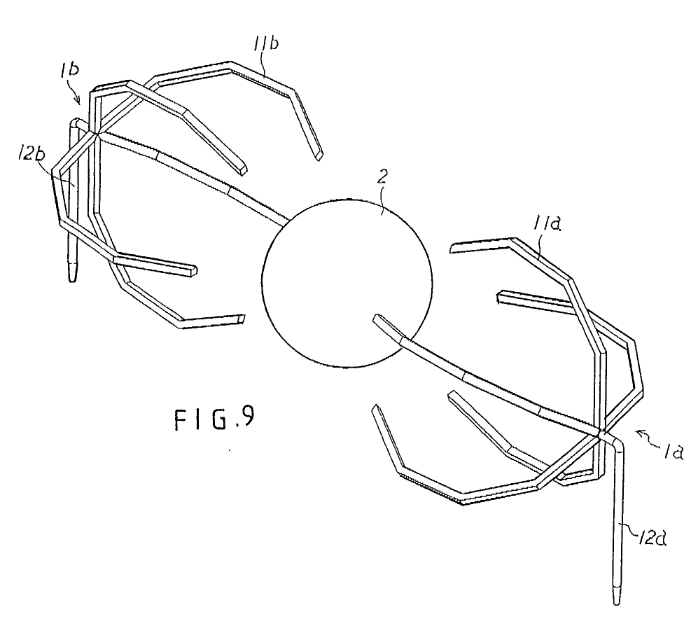

FIG. 9 shows that each of the first prongs 11a and the second prongs 11b may have multiple consecutive sections each extend at an angle.

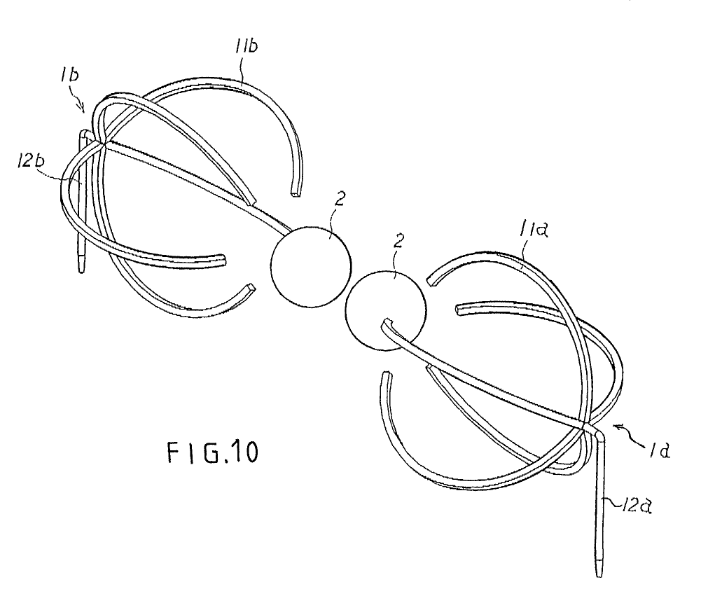

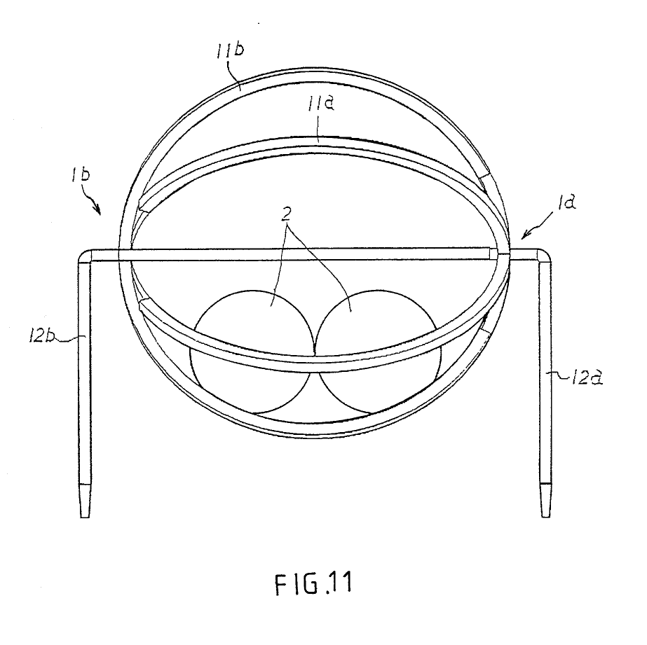

FIGS. 10 and 11 show that two balls 2 are received in the space defined by the first prongs 11a and the second prongs 11b. This could increase the sensibility of the sensor.

While we have shown and described the embodiment in accordance with the present invention, it should be clear to those skilled in the art that further embodiments may be made without departing from the scope of the present invention.

What is claimed is:

1. A vibration sensor comprising:
a first pawl having a first connection leg and a plurality of first prongs extending from the first connection legs;
a second pawl having a second connection leg and a plurality of second prongs extending from the second connection leg, the first prongs being arranged alternatively located between the second prongs so as to define a space, and
a ball located in the space and contacting one of the first prongs and one of the second prongs.

2. The sensor as claimed in claim 1, wherein each of the first prongs and the second prongs has a curvature.

3. The sensor as claimed in claim 1, wherein each of the first prongs and the second prongs includes multiple consecutive sections.
